(19) United States
(12) Patent Application Publication
(10) Pub. No.: US 2012/0000598 A1
(43) Pub. Date: Jan. 5, 2012

(54) METHOD FOR MANUFACTURING PLASTIC LABELS WITH SELF-ADHESIVE PATTERN, AND ATTACHING SUCH LABELS TO A TIN

(75) Inventor: Marc REYNDERS, Boechout (BE)

(73) Assignee: REYNDERS ETIKETTEN, NAAMLOZE VENNOOTSCHAP, Boechout (BE)

(21) Appl. No.: 13/170,756

(22) Filed: Jun. 28, 2011

(30) Foreign Application Priority Data
Jun. 30, 2010 (BE) 2010/0390

(51) Int. Cl. B29C 51/16

(52) U.S. Cl. 156/211; 156/212

(57) ABSTRACT

Method for manufacturing plastic labels with self-adhesive pattern, and attaching such labels such that they are enfolding a tin, whereby: a strip of plastic foil is printed using a digital printing technique, whereby the side edge of consecutive label prints on the strip is situated at right angles to the lengthwise direction; an adhesive is attached to the foil; a tin is enfolded by the foil, whereby a side edge is overlapped by another part of the foil, whereby the part of the foil that is enfolding the tin is adhering to the tin by the adhesive; a part of the foil is cut off.

The present invention relates to a method for manufacturing plastic labels with self-adhesive pattern, and attaching such labels such that they are enfolding a tin, a bottle, a pot, a can, a container, or the like.

Methods that are already known comprise the step of printing a plastic foil by using an analogue contact pressing technique and using plates or rolls that are pressed against the foil, for example in a relief printing, flexographic print and/or offset and intaglio print.

In such methods the plastic foil is formed as a wide band, whereby prints are printed successively on the wide band along the widthwise direction of this wide band, similar to the method for a label, and whereby the side edges of the label prints are aligned along the lengthwise direction of the band.

Because preparing the plates for printing is expensive and time-consuming, in practice, such a known method is only economically viable when manufacturing intermediate and large numbers of labels, provided that these labels all have the same print.

Moreover, printing intermediate and large series is expensive and labour intensive.

Therefore, a first disadvantage of such known method is that it is not very suitable to manufacture a smaller number of labels or labels of which the print is variable, for example, because each label has to be provided with a separate serial number, batch number, variable code, or the like.

Furthermore, to attach the labels to a tin, or the like, using known methods, each time a label has to be torn or cut off from the wide band, and both edges of the label have to be interconnected forming a closed band or flexible cover shaped band, better known as stretch sleeve or sleeve.

Mostly, interconnecting or sealing is carried out in an extra production line requiring extra processing time and thus incurring extra costs.

This band is radially pulled open in order to slide the band over the tin in the axial direction, after which the band again returns to its original form, due to its elasticity, and stretches around the tin.

Moreover, the way of attaching the labels is fairly complicated and requires specially suited equipment that is laborious and expensive.

Furthermore, these known methods usually provide the tin with a pair of circular ridges on a height each corresponding to the height of a label, in between which the label will be attached, which ridges function to guarantee that the label will remain at its position. Alternatively, sometimes the tin is provided with a recessed surface for that reason.

The present invention aims to offer a solution to said and other disadvantages.

Therefore, the present invention relates to a method for manufacturing plastic labels with a self-adhesive pattern, and attaching such labels around a tin, whereby, after attaching a label around a tin, a side edge of the label is overlapped by another part of the label, the method further comprising at least the following steps:

printing a plastic foil, formed as an elongated strip, using a digital printing technique, the prints being printed successively along the lengthwise direction of the strip corresponding to a label, the prints being positioned in a consecutive order in the lengthwise direction of the strip, and the side edges of the consecutive label prints being situated on the strip at right angles, in the crosswise direction of the strip;

applying an adhesive to the plastic foil, either to the whole surface of the plastic foil, or to only a part of it, forming a self-adhesive plastic foil;

enfolding a tin by means of a free end of the plastic foil having a length of at least the length of the circumference of the tin, or the like, whereby after enfolding an aforementioned side edge of a label print is overlapped by another part of the plastic foil, and whereby the part of the foil enfolding the tin adheres to the tin by means of said adhesive; and,

cutting off the concerning part from the plastic foil corresponding to the length of a label.

A first advantage of this method according to the invention is that a digital printing technique is used.

Such printing techniques, without printing plates or printing cylinders, are cheaper and allow the print on the labels to be adjusted in a very flexible way, without having to use long lasting and expensive procedures, due to the fact that the print can be adjusted softwarewise.

Another advantage of a method according to the invention is that it is suitable for very small to intermediate numbers of labels, because there is no need to produce plates, or the like, for printing.

Printing digitally is less expensive compared to printing traditionally.

Moreover, welding to make a closed band (sleeve) is not required.

Furthermore, the method according to the invention for attaching the labels to a tin is carried out in a far more efficient way.

The method according to the invention allows the labels to be attached to a tin in a practical, continuous and quick way.

After all, it suffices to enfold a tin with the plastic foil and to cut the latter at the correct length, after which another tin may be delivered and the process may be repeated.

In order to better explain the characteristics of the invention, hereafter, by means of example only, without being limitative in any way, a preferred method according to the invention for manufacturing self-adhesive plastic labels, and attaching such labels to a tin is explained in detail with reference to individual figures, in which:

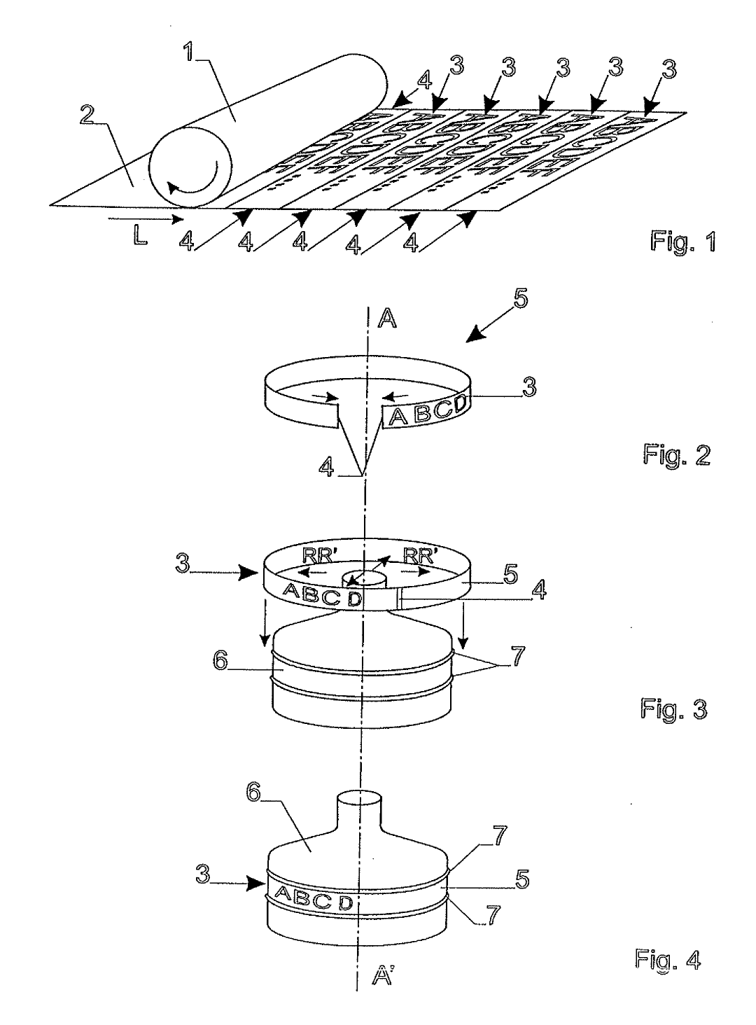

FIGS. 1 to 4 show consecutive steps of a known method; and,

FIGS. 5 to 9 show steps of a method according to the invention.

In FIG. 1 a first step of a known method for manufacturing plastic labels, and attaching such labels to a tin is shown schematically.

Hereby, an analogue contact printing technique is used, whereby prints 3 corresponding to a label are printed on the wide band 2 by the contact between a printing cylinder 1 and a plastic foil in the form of a wide band 2.

Hereby, the side edges 4 of the consecutive label prints 3 on the foil 2 are aligned according to the lengthwise direction L of the wide band 2.

In this text the side edges 4 of a label 5 are defined as the edges 4 of the label 5 meant to be extended along the axial direction AA′ of a tin 6, with regular use of the label 5, and after attaching the label 5 to the tin 6.

FIG. 2 shows schematically that with the known methods, after cutting off or tearing away a label 5 of the foil 2, a following step comprises interconnecting said side edges 4 of the label 5, for example by glueing or melting them together, such that a label 5 in the form of a closed band is obtained.

As is represented in FIG. 3, according to the known methods, after that, the label 5, in the form of a band, will be stretched in the radial direction RR′, in order to move it in the axial direction AA′ over the tin 6.

Hereby, the label 5 is positioned between two annular ridges 7, and then the step of stretching the label 5 radially is ended due to its elasticity, and the label 5 again returns to its original dimensions due to its elasticity and is thus tightened around the tin 6.

This condition is represented in FIG. 4.

As an alternative for the ridges 7 sometimes a recessed plane in the tin 6 is used, in which the label 5 is positioned.

The disadvantages of such a method were already discussed extensively in the introduction.

Hereafter, with reference to FIGS. 5 to 9, a method according to the invention will be described for manufacturing self-adhesive plastic labels 5, and attaching such labels 5 such that they are enfolding a tin 6, which method offers numerous advantages in relation to the known method described above, as also already cited in the introduction.

A first step of a method according to the invention is represented in FIG. 5 and comprises imprinting a plastic foil in the form of a elongated strip 8 using a digital printing technique.

To this end, for example, a digital printer 9 controlled by a controlling system 10 may be used.

Moreover, according to the invention, it is preferred that a contactless printing technique is used for printing the plastic foil 8, for example by means of an inkjet-printer 9.

An advantage of using a digital printing technique is that the images to be printed on the labels 5 are able to be prepared and adjusted using software of the controlling system 10, as a result of which a lot of time can be saved and the costs can be lowered strongly.

Moreover, it is a very efficient method which also allows to realise small and intermediate series of labels 5 in an economically viable way.

As is represented in FIG. 5, using a method according to the invention, prints 3 corresponding to a label 5 are printed successively along the lengthwise direction L′ of the strip 8.

Hereby, the side edges 4 of consecutive label prints 3 on the strip 8 are situated at right angles, along the direction P crosswise to the lengthwise direction L′ of the strip.

As represented schematically in FIG. 5, using a method according to the invention, an adhesive 11 is applied on the plastic foil 8, in order to obtain self-adhesive labels 5.

Preferably, this adhesive 11 is applied to parts of the plastic foil 8 that are not imprinted or not be imprinted.

Applying the adhesive 11 may be carried out before printing the foil 8, but also after the foil 8 has been printed.

Preferably, according to the invention, said adhesive 11 is a detachable thermoplastic adhesive substance 11.

Preferably, the adhesive 11 is also such that a good adherence is obtained between the plastic foil 8 and a tin 6, while the plastic foil 8 may be removed easily from the tin 6 without leaving traces of adhesive 11 on the tin 6.

Of course, these features depend on the material that is used to produce the foil 8, as well as the tin 6.

Furthermore, according to the invention, it is not required to provide the entire parts of the foil 8 that are not imprinted or not be imprinted with adhesive 11.

After all, it may suffice to apply such adhesive patterns 11 that allow adherence of the foil 8 to the tin 6, as well as removal of the foil 8 from the tin 6 without leaving traces.

Preferably, a method according to the invention also comprises an additional step, comprising, after printing, applying a layer on at least one part of the prints 3, in order to avoid adherence of the adhesive 11 to the prints 3.

For example, for such a layer a silicone or wax layer 12 may be used.

This step is also represented schematically in FIG. 5.

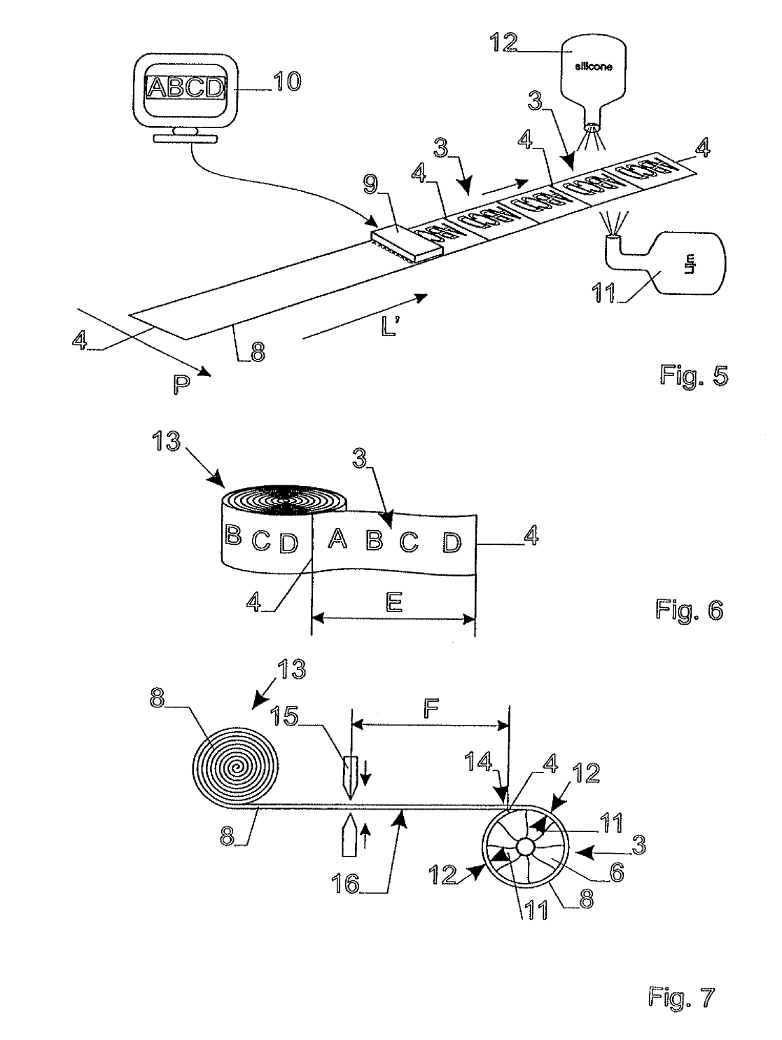

The intention of attaching such layer 12 is that it is possible to roll the long strip 8, after applying the adhesive 11, into a roll 13, as represented in FIG. 6.

Hereby, said layer 12 avoids that the adjacent parts forming the roll 13 will start to adhere to each other.

The actual attachment of a label 5 to a tin 6, according to a method according to the invention, is illustrated with reference to the FIGS. 7 to 9.

A first step, represented schematically in the top view of FIG. 7, comprises to unroll a free end of the plastic foil 8 of the roll 13 to enfold the tin 6 with at least a length corresponding to the circumference of the tin 6.

Consequently the length E of a label 5 is therefore larger than the circumference of the tin 6.

As is represented also in FIG. 7, the intention of the invention in fact is that after enfolding the tin 6 using this part of the foil 8 with length E an aforementioned side edge 4 of a label print 3 is overlapped by another part 14 of the plastic foil.

Of course, during enfolding the tin 6 care is taken that the side of the foil 8 provided with adhesive 11 is directed towards the tin 6.

According to the invention it is the intention that during enfolding the tin 6 said free end of the plastic foil 8 is glued to this tin 6 by means of the adhesive 11.

Furthermore, according to the invention, the side edge 4 and the overlapping part 14 of the plastic foil 8 are preferably interconnected in one movement during enfolding by means of this adhesive 11.

Finally, a label 5 is cut off from the roll 13 using cutting means 15, for example in the form of a knife or a laser, or the like, whereby a part of the plastic foil 8 is cut off corresponding to the length E of a label 5.

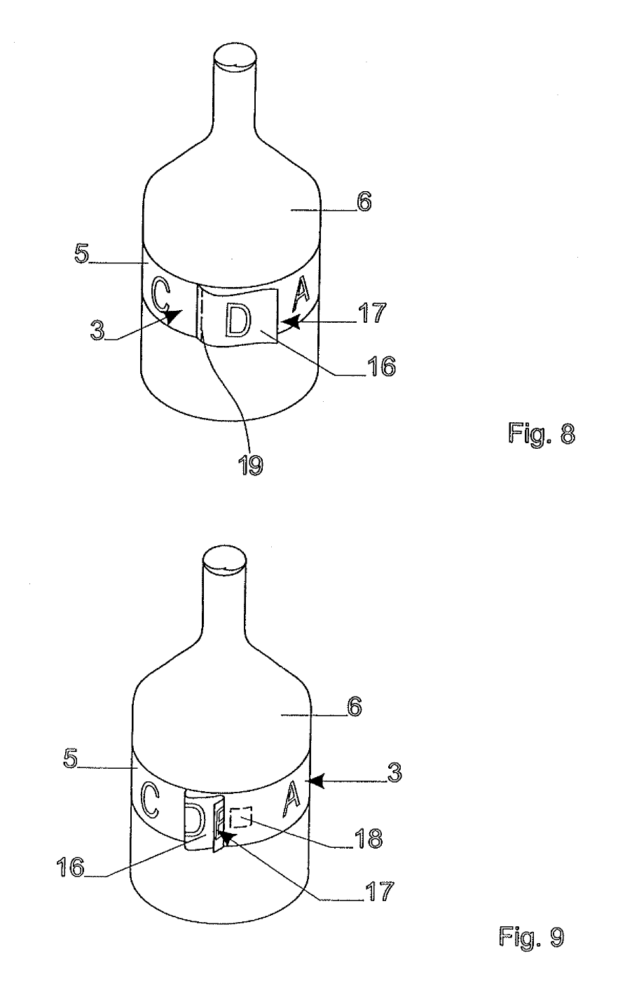

As is represented clearly in FIG. 8, according to the invention it is preferred that the label 5 is cut off at a certain distance F from the overlapping part 14 and the side edge 4 of the plastic foil 8, whereby initially the label 5 is provided with a flap 16.

Besides, it is preferred that this flap 16 at its free edge 17 is provided with an adhesive-free strip or an adhesive-free part, such that the flap 16 can be teared-off easily from the rest of the label 5 or the label 5 can be teared-off easily from the tin 6.

According a preferred method according to the invention this flap 16 may be provided on one side or on both sides with a print, as represented schematically in FIG. 9.

For example, this could be useful for providing a text, like instructions, and the like.

Another interesting step of a method according to the invention is the application of perforations through the plastic foil 8 forming a tear-out strip 18 in a label 5.

Such a tear-out strip 18 is also represented in FIG. 9 and may for example be used for the traceability of the product in the tins 6 or of empty tins 6.

As an alternative, a tear-away strip may be used that, for example, can be formed as a flap 16 and whereby a perforation line 19 is provided at the side edge of the flap 16 in order to tear away the flap 16 easily.

Such a perforation line 19 is represented in FIG. 8 by way of example.

Another preferred aspect of the invention is that the plastic foil 8 is stretchable in order to be able to follow expansion and shrinkage of a tin 6 onto which the plastic foil 8 is adhered when temperature changes.

The present invention is by no means limited to the exemplary, and with reference to the figures illustrated, embodiment of a method according to the invention, however, a method according to the invention may be accomplished in various forms and dimensions while still remaining within the scope of the appended claims.

1. Method for manufacturing plastic labels (5) with a self-adhesive pattern, and attaching such labels (5) such that they are enfolding a tin (6), characterised in that it comprises the step of overlapping a side edge (4) of the label (5) by another part (14) of the label (5) after attaching said label (5) such that it is enfolding a tin (6), and that it comprises at least the following steps:
Printing a plastic foil (8) in the form of a elongated strip (8) using a digital printing technique, whereby successively along the lengthwise direction (L′) of the strip (8) prints (3) are being printed corresponding to a label (5), whereby the prints (3) follow each other in the lengthwise direction (L′) of the strip (8), and whereby the side edges (4) of consecutive label prints (3) on the strip (8) are situated at right angles, along the direction (P) crosswise to the lengthwise direction (L′) of the strip (8);
Applying adhesive (11) on the plastic foil (8), either on the whole surface of the plastic foil (8), or on only a part of it, forming a self-adhesive plastic foil (8);
Enfolding a tin (6) by means of a free end of the plastic foil (8) with a length (E) at least corresponding to the circumference of the tin (6), or the like, whereby, after enfolding, an aforementioned side edge (4) of a label print (3) is overlapped by another part (14) of the plastic foil (8) and whereby the part of the foil (14) that is enfolding the tin (6) adheres to the tin (6) by means of said adhesive (11); and,
Cutting off the concerning part of the plastic foil (8) corresponding to the length (E) of a label (5).

2. Method according to claim 1, characterised in that a contactless printing technique is used for printing the plastic foil (8).

3. Method according to claim 1, characterised in that perforations are provided through the plastic foil (8) forming a tear-out strip (18) in a label (5) or a perforation line (19) is provided at a side edge of a flap (16) forming a tear-away strip.

4. Method according to claim 1, characterised in that said adhesive (11) is a detachable thermoplastic adhesive substance (11).

5. Method according to claim 1, characterised in that it comprises the step of using such an adhesive (11) that is able to provide a good adherence between the plastic foil (8) and the tin (6), and also to make it possible to tear off the plastic foil (8) from the tin (6) easily without leaving traces of adhesive (11) on the tin (6).

6. Method according to claim 4, characterised in that it additionally comprises the step of, applying a layer (12) to at least one part of the prints (3), after printing, in order to avoid adherence of the adhesive (11) to the prints (3).

7. Method according to claim 6, characterised in that said layer (12) is a silicon (12) of wax layer.

8. Method according to claim 4, characterised in that after enfolding the tin (6) with the foil (8), the side edge (4) and the overlapping part (14) are at least partially interconnected.

9. Method according to claim 8, characterised in that the side edge (4) and the overlapping part (14) of the plastic foil (8) are at least partially interconnected by means of said adhesive (11).

10. Method according to claim 1, characterised in that the label (5) is cut off at a certain distance (F) from the overlapping part (14) and the side edge (4) of the plastic foil (8), providing a flap (16) at the label (5).

11. Method according to claim 10, characterised in that the flap (16) at its free edge (17) is provided with an adhesive-free strip (11) or adhesive-free part.

12. Method according to claim 11, characterised in that the flap (16) on one of the sides or on both sides is provided with a print (3).

13. Method according to claim 1, characterised in that the plastic foil (8) is stretchable in order to be able to follow expansions and shrinkage of a tin (6) onto which the plastic foil (8) is adhered when temperature changes.

14. Method according to claim 2, characterised in that perforations are provided through the plastic foil (8) forming a tear-out strip (18) in a label (5) or a perforation line (19) is provided at a side edge of a flap (16) forming a tear-away strip.

15. Method according to claim 2, characterised in that said adhesive (11) is a detachable thermoplastic adhesive substance (11).

16. Method according to claim 3, characterised in that said adhesive (11) is a detachable thermoplastic adhesive substance (11).

17. Method according to claim 2, characterised in that it comprises the step of using such an adhesive (11) that is able to provide a good adherence between the plastic foil (8) and the tin (6), and also to make it possible to tear off the plastic foil (8) from the tin (6) easily without leaving traces of adhesive (11) on the tin (6).

18. Method according to claim 3, characterised in that it comprises the step of using such an adhesive (11) that is able to provide a good adherence between the plastic foil (8) and the tin (6), and also to make it possible to tear off the plastic foil (8) from the tin (6) easily without leaving traces of adhesive (11) on the tin (6).

19. Method according to claim 4, characterised in that it comprises the step of using such an adhesive (11) that is able to provide a good adherence between the plastic foil (8) and the tin (6), and also to make it possible to tear off the plastic foil (8) from the tin (6) easily without leaving traces of adhesive (11) on the tin (6).

20. Method according to claim 5, characterised in that it additionally comprises the step of, applying a layer (12) to at least one part of the prints (3), after printing, in order to avoid adherence of the adhesive (11) to the prints (3).
